(19) United States
(12) Patent Application Publication
(10) Pub. No.: US 2026/0179864 A1
(43) Pub. Date: Jun. 25, 2026

(54) KEY DEVICE FOR KEYBOARD

(71) Applicant: SUNREX TECHNOLOGY CORP., Taichung City (TW)

(72) Inventors: Yin CHU, Chongqing City (CN); Bao-Song Ma, Chongqing City (CN); Shih-Pin Lin, Taichung City (TW); Hua-Jun Tang, Chongqing City (CN)

(73) Assignee: SUNREX TECHNOLOGY CORP., Taichung City (TW)

(21) Appl. No.: 19/077,959

(22) Filed: Mar. 12, 2025

(30) Foreign Application Priority Data
Dec. 24, 2024 (TW) 113214193

(51) Int. Cl. H01H 13/52; H01H 13/02; H01H 13/04; H01H 13/10

(52) U.S. Cl. CPC H01H 13/52; H01H 13/023; H01H 13/04; H01H 13/10; H01H 2013/525

(57) ABSTRACT

A key device includes a circuit board unit, a position unit, a scissor linkage, a resilient member and a keycap. The position unit includes a surrounding frame defining an inner hole, and two first connection subunits and two second connection subunits connected to the surrounding frame. An imaginary plane is formed in the inner hole and is coplanar with a top surface of the surrounding frame. Each of the first and second connection subunits has one connection plate, and a connection portion extending from the connection plate to be higher than the top surface, and having a guide surface facing the imaginary plane. The scissor linkage includes first and second frame members pivotally connected to each other. The first and second frame members each have two lower rods. Each of the lower rods of the first and second frame members abuts against a respective guide surface.

### CROSS-REFERENCE TO RELATED APPLICATION

This application claims priority to Taiwanese Utility Model Patent Application No. 113214193, filed on Dec. 24, 2024, the entire disclosure of which is incorporated by reference herein.

### FIELD

The present disclosure relates to an input apparatus, and more particularly to a key device for a keyboard.

### BACKGROUND

A conventional light emitting key device for a keyboard (as disclosed in Taiwanese Invention Patent Application Publication No. 202441541A) includes a driving circuit board having a plurality of light emitting members, a spacer, a bottom plate having a plurality of hooks, a switch circuit board having a switch, a resilient restoring member, a lifting mechanism having a plurality of pivot shafts, and a keycap in sequence from bottom to top. The lifting mechanism is connected between the bottom plate and the keycap, so that the keycap can move downwardly or upwardly relative to the bottom plate through the lifting mechanism when being pressed or released. The resilient restoring member is disposed between the keycap and the switch; specifically, the resilient restoring member is directly disposed on a top of the switch. When the keycap is pressed downwardly to compress the resilient restoring member, the resilient restoring member triggers the switch to function the conventional light emitting key device.

The above-mentioned structure can achieve the intended purpose of operation; however, when the lifting mechanism is being assembled to the bottom plate, the pivot shafts of the lifting mechanism are to be engaged with the hooks of the bottom plate. In the process of engagement, the pivot shafts may be broken, and the hooks may be deformed, which leads to quality problems such as components of the conventional light emitting key device falling off, height difference, and tilting.

In order to alleviate the above quality problems, special jigs and workstations have to be set up in the manufacturing process, resulting in a prolonged manufacturing process and reduced productivity.

### SUMMARY

Therefore, an object of the disclosure is to provide a key device for a keyboard that can alleviate at least one of the drawbacks of the prior art.

According to the disclosure, the key device includes a circuit board unit, a position unit, a scissor linkage, a resilient member and a keycap. The position unit is disposed on the circuit board unit, and includes a surrounding frame that defines an inner hole, and that has a bottom surface and a top surface opposite to the bottom surface, a pair of first connection subunits that are connected to the surrounding frame, and a pair of second connection subunits that are connected to the surrounding frame. An imaginary plane is formed in the inner hole and is coplanar with the top surface. Each of the pair of first connection subunits has at least one connection plate that is connected to the surrounding frame, and a connection portion that is connected to and extends from the at least one connection plate to be higher than the top surface in a height direction of the key device, and that has a guide surface facing the imaginary plane. The height direction is a direction from the bottom surface towards the top surface. Each of the pair of second connection subunits has at least one connection plate that is connected to the surrounding frame, and a connection portion that is connected to and extends from the at least one connection plate to be higher than the top surface in the height direction, and that has a guide surface facing the imaginary plane. The scissor linkage is mounted to the position unit in the height direction from the bottom surface towards the top surface, and includes a first frame member and a second frame member that are pivotally connected to each other and that cooperatively define a through hole. The first frame member has two lower rods that are respectively and pivotally connected to the connection portions of the pair of first connection subunits, and two upper rods. The second frame member has two lower rods that are respectively and pivotally connected to the connection portions of the pair of second connection subunits, and two upper rods. For the first frame member, each of the lower rods abuts against the guide surface of the respective one of the connection portions of the pair of first connection subunits, and for the second frame member, each of the lower rods abuts against the guide surface of the respective one of the connection portions of the pair of second connection subunits. The resilient member is disposed on the circuit board unit and extends through the through hole. The keycap has a pair of first pivot portions that are respectively and pivotally connected to the upper rods of the first frame member, and a pair of second pivot portions that are respectively and pivotally connected to the upper rods of the second frame member.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a partly exploded perspective view of a first embodiment of a key device according to the present disclosure.

FIG. 2 is a perspective view of a position unit of the first embodiment.

FIG. 3 is a schematic side view of the position unit.

FIG. 4 is a perspective view of the first embodiment, wherein a keycap is omitted.

FIG. 5 is a top view of the first embodiment shown in FIG. 4.

FIG. 6 is a sectional view taken along line VI-VI of FIG. 5.

FIG. 7 is an exploded perspective view of a second embodiment of the key device according to the present disclosure.

FIG. 8 is a perspective view of a position unit of the second embodiment.

FIG. 9 is a schematic side view of the position unit.

FIG. 10 is a perspective view of the second embodiment, wherein a keycap is omitted.

FIG. 11 is a top view of the second embodiment shown in FIG. 10.

FIG. 12 is a sectional view taken along line XII-XII of FIG. 11.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

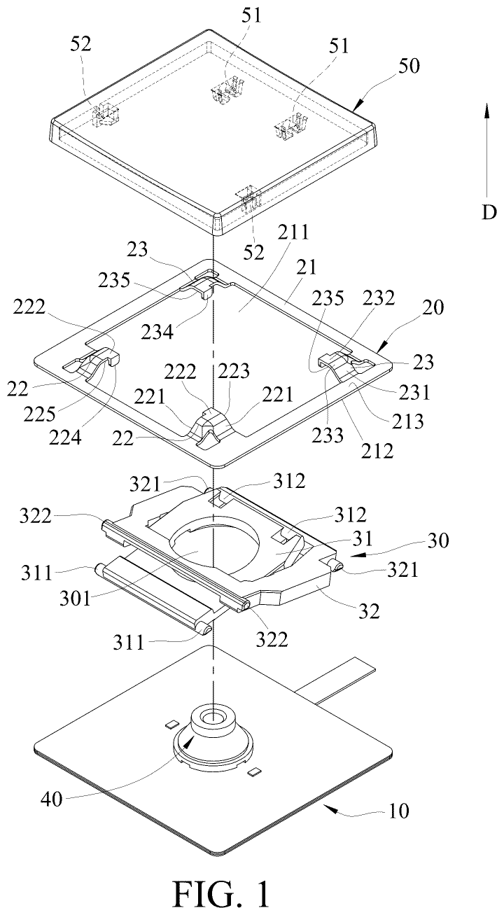

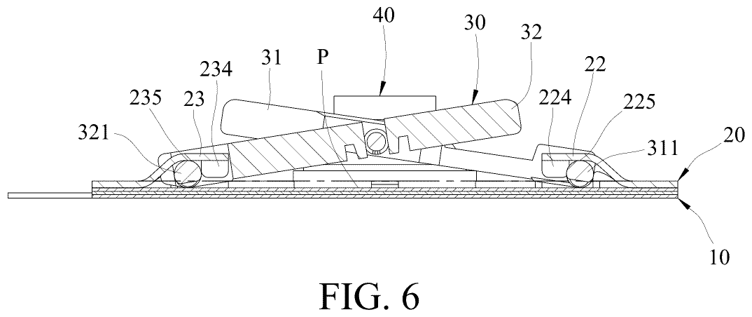

Referring to FIGS. 1 and 6, a first embodiment of a key device for a keyboard of the present disclosure includes a circuit board unit 10, a position unit 20, a scissor linkage 30, a resilient member 40, and a keycap 50.

The circuit board unit 10 may be a three-in-one liquid-proof backlight film, i.e., a thin film circuit board having one or more of backlight modules (not shown), but is not limited thereto.

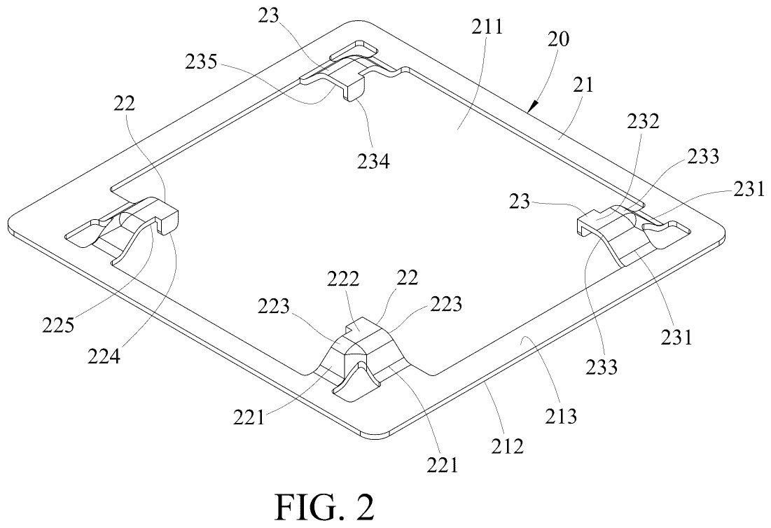

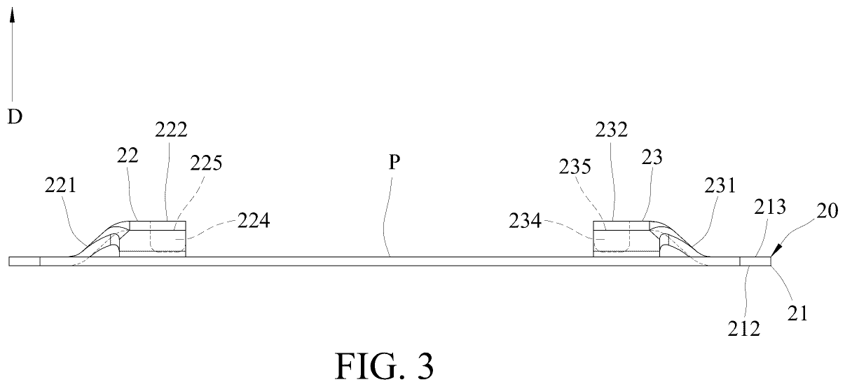

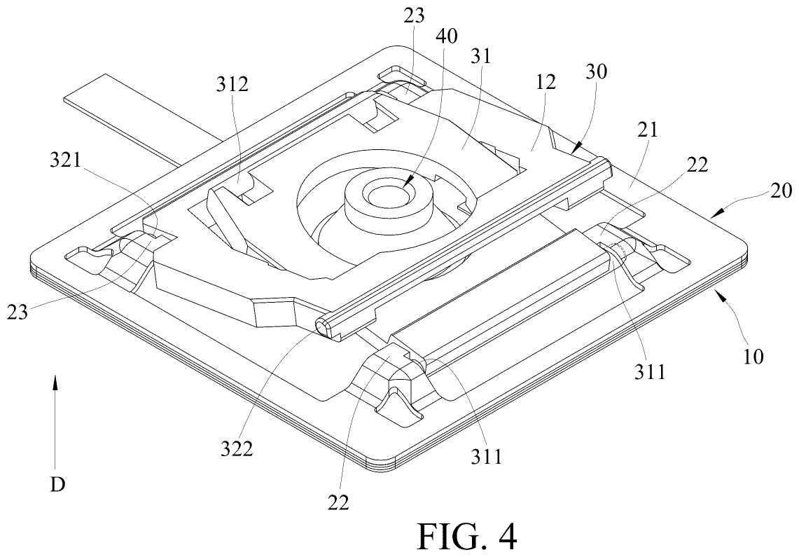

Referring to FIG. 2 and FIG. 3, the position unit 20 is disposed on the circuit board unit 10 (see FIG. 4), and includes a surrounding frame 21 that defines an inner hole 211, and that has a bottom surface 212 and a top surface 213 opposite to the bottom surface 212, a pair of first connection subunits 22 that are connected to the surrounding frame 21, and a pair of second connection subunits 23 that are connected to the surrounding frame 21. In this embodiment, the position unit 20 is formed from a metal plate (e.g., a stainless steel plate or an aluminum plate), and is integrally formed by stamping (i.e., the position unit 20 is a one-piece component); that is, the first connection subunits 22 and the second connection subunits 23 are integrally connected to the surrounding frame 21. An imaginary plane (P) is formed in the inner hole 211 and is coplanar with the top surface 213. Each of the first connection subunits 22 has at least one connection plate 221 that is connected to the surrounding frame 21, a connection portion 222 that is connected to and extends from the at least one connection plate 221 to be higher than the top surface 213 in a height direction (D) of the key device, and that has a guide surface 225 facing the imaginary plane (P), at least one guide arc portion 223 that is connected between the at least one connection plate 221 and the connection portion 222, and a stop portion 224 that is connected to the connection portion 222. The height direction (D) is a direction from the bottom surface 212 towards the top surface 213. In this embodiment, each of the first connection subunits 22 has two connection plates 221 and two guide arc portions 223, but is not limited to such. Each of the connection plates 221 extends from the surrounding frame 21 and away from the imaginary plane (P) when extending towards a central portion of the inner hole 211. Each of the second connection subunits 23 has at least one connection plate 231 that is connected to the surrounding frame 21, a connection portion 232 that is connected to and extends from the at least one connection plate 231 to be higher than the top surface 213 in the height direction (D), and that has a guide surface 235 facing the imaginary plane (P), at least one guide arc portion 233 that is connected between the at least one connection plate 231 and the connection portion 232, and a stop portion 234 that is connected to the connection portion 232. In this embodiment, each of the second connection subunits 23 has two connection plates 231 and two guide arc portions 233, but is not limited to such. Each of the connection plates 231 extends from the surrounding frame 21 and away from the imaginary plane (P) when extending towards the central portion of the inner hole 211.

The scissor linkage 30 is mounted to the position unit 20 in the height direction (D), and includes a first frame member 31 and a second frame member 32 that are pivotally connected to each other and that cooperatively define a through hole 301 (see FIG. 1). The first frame member 31 has two lower rods 311 that are respectively and pivotally connected to the connection portions 222 of the first connection subunits 22, and two upper rods 312. The second frame member 32 has two lower rods 321 that are respectively and pivotally connected to the connection portions 232 of the second connection subunits 23, and two upper rods 322. Specifically, for the first frame member 31, each of the lower rods 311 abuts against the guide surface 225 of the respective one of the connection portions 222 of the first connection subunits 22, and for the second frame member 32, each of the lower rods 321 abuts against the guide surface 235 of the respective one of the connection portions 232 of the second connection subunits 23.

The resilient member 40 is disposed on the circuit board unit 10 and extends through the through hole 301 and the inner hole 211.

The keycap 50 abuts against a top portion of the resilient member 40, and has a pair of first pivot portions 51 that are respectively and pivotally connected to the upper rods 312 of the first frame member 31, and a pair of second pivot portions 52 that are respectively and pivotally connected to the upper rods 322 of the second frame member 32.

The following description may be helpful in further understanding the generated effects of the components of the disclosure, the technical methods that are utilized, and the object that is expected to be achieved.

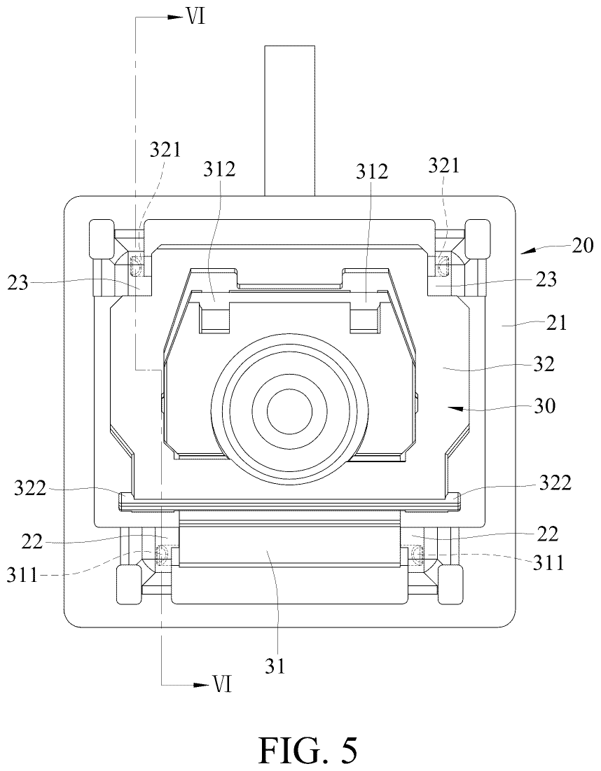

Referring to FIGS. 4 to 6, when the key device is being assembled, the scissor linkage 30 is mounted to the position unit 20 in the height direction (D) (i.e., in a direction from the bottom surface 212 towards the top surface 213), so that each of the lower rods 311 of the first frame member 31 abuts against the respective guide surface 225, and each of the lower rods 321 of the second frame member 32 abuts against the respective guide surface 235. The upper rods 312 of the first frame member 31 and the upper rods 322 of the second frame member 32 extend through the inner hole 211 to be located higher than the imaginary plane (P) in the height direction (D).

Then, the circuit board unit 10 mounted with the resilient member 40 is abutted against the bottom surface 212 of the position unit 20 in the height direction (D). Finally, the keycap 50 is pressed toward the scissor linkage 30 and abutted against the top portion of the resilient member 40, so that the upper rods 312 of the first frame member 31 are respectively and pivotally connected to the first pivot portions 51, and the upper rods 322 of the second frame member 32 are respectively and pivotally connected to the second pivot portions 52.

When the key device has been assembled, and when the keycap 50 is not being pressed, the keycap 50 remains in an original state away from the position unit 20 by a resilient force provided by the resilient member 40, and the scissor linkage 30 is in an extension state (i.e., the lower rods 311 of the first frame member 31 are away from the upper rods 322 of the second frame member 32, and the upper rods 312 of the first frame member 31 are away from the lower rods 321 of the second frame member 32). When the keycap 50 is being pressed, the scissor linkage 30 is in a contraction state (i.e., the lower rods 311 of the first frame member 31 are adjacent to the upper rods 322 of the second frame member 32, and the upper rods 312 of the first frame member 31 are adjacent to the lower rods 321 of the second frame member 32), so that the keycap 50 approaches the position unit 20 and presses the resilient member 40 towards the circuit board unit 10 (meanwhile, the resilient member 40 stores an resilient force for releasing), and the circuit board unit 10 is triggered by the resilient member 40 to generate a signal.

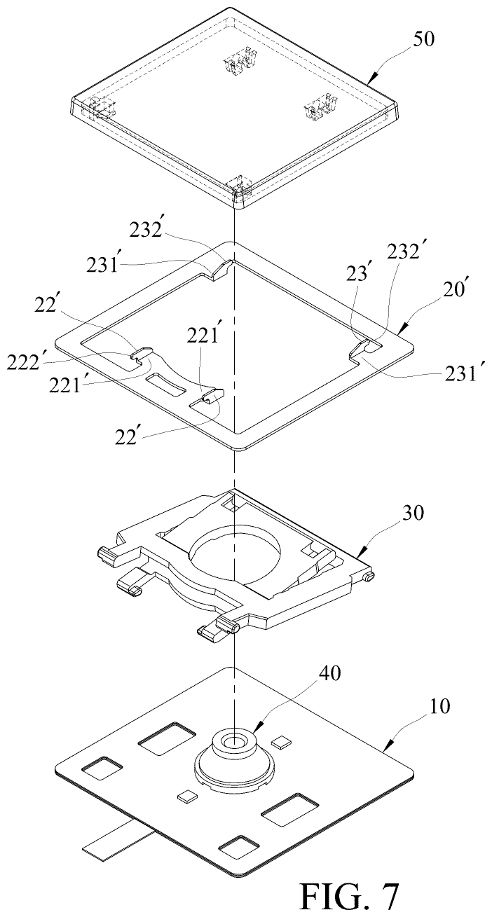

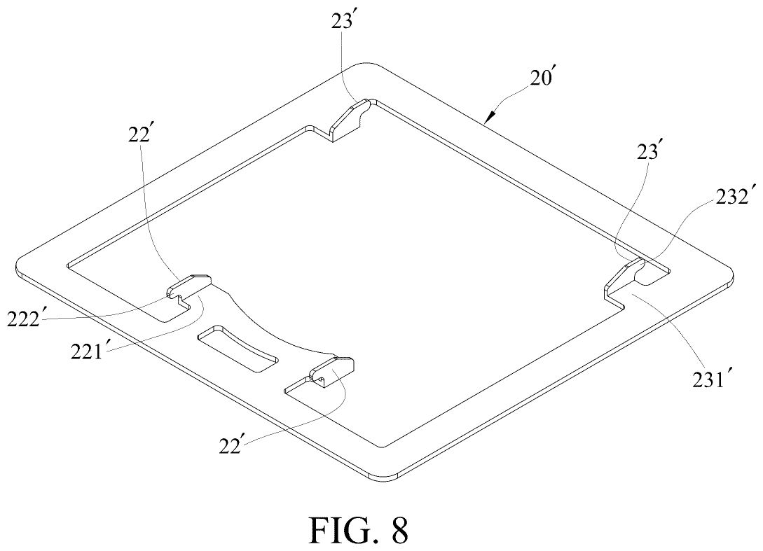

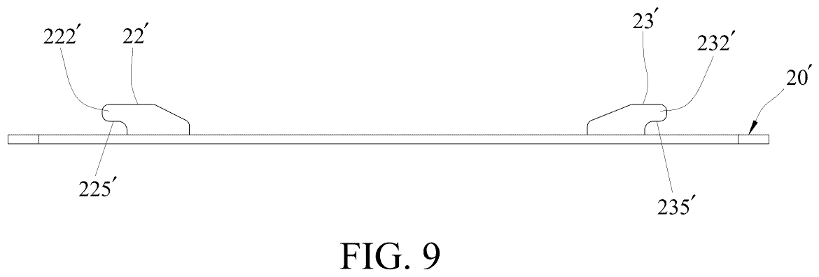

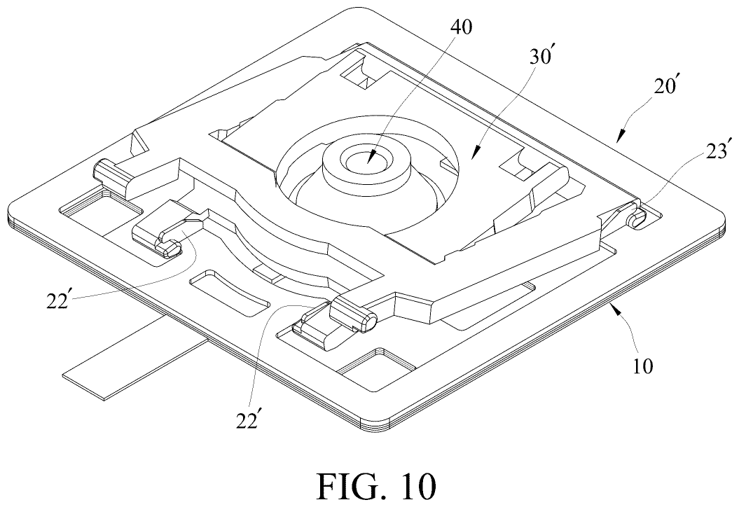

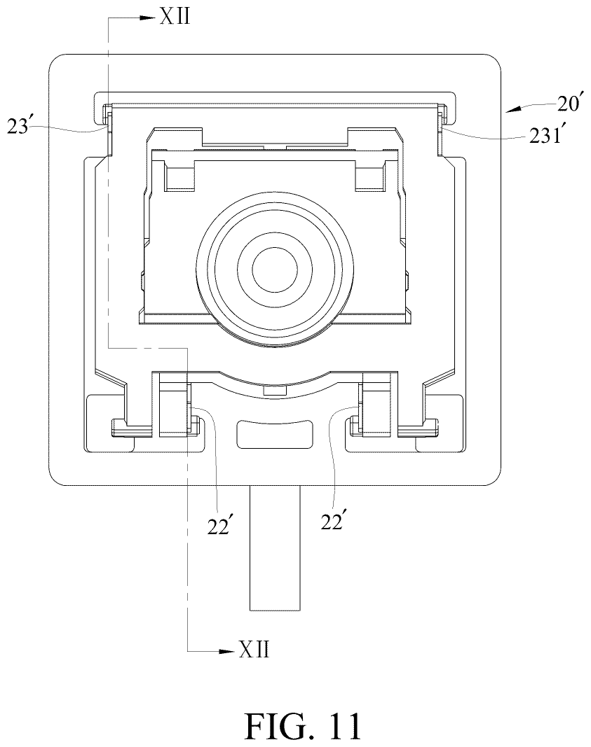

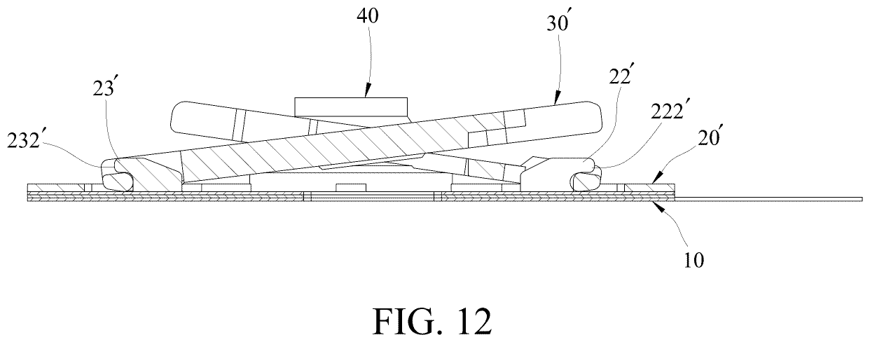

As shown in FIGS. 7 to 12, a second embodiment of the present disclosure is similar to the first embodiment, and the differences therebetween are illustrated in the following. In the second embodiment, the guide arc portions 223 and the stop portions 224 of the first connection subunits 22 and the guide arc portions 233 and the stop portions 234 of the second connection subunits 23 are omitted; in addition, for each of the first connection subunits 22′, there are one connection plate 221′ and one connection portion 222′, and for each of the second connection subunits 23′, there are one connection plate 231′ and one connection portion 232′. Besides, for each of the first connection subunits 22′, the connection plate 221′ and the connection portion 222′ are interconnected to form an L-shape, the connection portion 222′ is inverted L-shaped, and the connection plates 221′ of the first connection subunits 22′ are interconnected; for each of the second connection subunits 23′, the one connection plate 231′ and the connection portion 232′ are interconnected to form an L-shape, and the connection portion 232′ is inverted L-shaped.

Therefore, the second embodiment of the present disclosure can achieve the same object and effects as the first embodiment.

The advantages and effects of the present disclosure can be summarized as follows.

1. In a manufacturing process of the key device of the disclosure, the scissor linkage 30 is positioned through being directly mounted to the position unit 20 in the height direction (D) without engaging a bottom plate, and thus costs for manpower, equipment and jigs for the engagement of the scissor linkage 30 with the bottom plate can be eliminated, and workstations for the engagement are removed, which significantly improves the production capacity of the disclosure and saves costs.

2. Since the scissor linkage 30 is positioned without engaging the bottom plate, damage to the upper rods 312, 322 and the lower rods 311, 321 and deformation of the bottom plate and the connection portions 222, 222′, 232, 232′ that may occur in the engagement process of a conventional key device are avoided, so that quality problems such as components of the conventional light emitting key device falling off, height difference, and tilting are eliminated, which improves the quality of the product.

3. The lightweight embossed structure (i.e., the structure of each of the first and second connection subunits 22, 22′, 23, 23′) may have problems such as difficult assembly, insufficient interference, shaking, and other factors hindering mass production; through the disclosure, the abovementioned problems can be alleviated, allowing the lightweight embossed structure to be better promoted, which increases competitiveness of the lightweight embossed structure in the lightweight notebook keyboard field.

4. Since a center portion of the position unit 20 is cut off (i.e., the inner hole 211), except for the scissor linkage 30, light-emitting elements of the backlight module are not blocked by any components, and thus the backlight effect is more uniform and brighter.

In summary, the key device for a keyboard of the present disclosure has a simple structure, is easy to be assembled, may reduce the defect rate during production, and may improve productivity, which indeed achieves the object of the present disclosure.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A key device for a keyboard, comprising:
a circuit board unit;
a position unit disposed on said circuit board unit, and including a surrounding frame that defines an inner hole, and that has a bottom surface and a top surface opposite to said bottom surface, a pair of first connection subunits that are connected to said surrounding frame, and a pair of second connection subunits that are connected to said surrounding frame,
wherein an imaginary plane is formed in said inner hole and is coplanar with said top surface,
wherein each of said pair of first connection subunits has at least one connection plate that is connected to said surrounding frame, and a connection portion that is connected to and extends from said at least one connection plate to be higher than said top surface in a height direction of said key device, and that has a guide surface facing the imaginary plane, the height direction being a direction from said bottom surface towards said top surface, and
wherein each of said pair of second connection subunits has at least one connection plate that is connected to said surrounding frame, and a connection portion that is connected to and extends from said at least one connection plate to be higher than said top surface in the height direction, and that has a guide surface facing the imaginary plane;
a scissor linkage mounted to said position unit in the height direction from said bottom surface towards said top surface, and including a first frame member and a second frame member that are pivotally connected to each other and that cooperatively define a through hole, said first frame member having two lower rods that are respectively and pivotally connected to said connection portions of said pair of first connection subunits, and two upper rods, said second frame member having two lower rods that are respectively and pivotally connected to said connection portions of said pair of second connection subunits, and two upper rods,
wherein for said first frame member, each of said lower rods abuts against said guide surface of the respective one of said connection portions of said pair of first connection subunits, and
wherein for said second frame member, each of said lower rods abuts against said guide surface of the respective one of said connection portions of said pair of second connection subunits;
a resilient member disposed on said circuit board unit and extending through said through hole; and
a keycap having a pair of first pivot portions that are respectively and pivotally connected to said upper rods of said first frame member, and a pair of second pivot portions that are respectively and pivotally connected to said upper rods of said second frame member.

2. The key device as claimed in claim 1, wherein said position unit is formed from a metal plate, and is integrally formed by stamping.

3. The key device as claimed in claim 2, wherein
for each of said pair of first connection subunits, said first connection subunit further has a stop portion that is connected to said connection portion, and
for each of said pair of second connection subunits, said second connection subunit further has a stop portion that is connected to said connection portion.

4. The key device as claimed in claim 2, wherein said at least one connection plate of each of said pair of first connection subunits extends from said surrounding frame and away from the imaginary plane when extending towards a central portion of said inner hole, and said at least one connection plate of each of said pair of second connection subunits extends from said surrounding frame and away from the imaginary plane when extending towards said central portion of said inner hole.

5. The key device as claimed in claim 2, wherein
for each of said pair of first connection subunits, said first connection subunit further has at least one guide arc portion that is connected between said at least one connection plate and said connection portion, and
for each of said pair of second connection subunits, said second connection subunit further has at least one guide arc portion that is connected between said at least one connection plate and said connection portion.

6. The key device as claimed in claim 2, wherein
for each of said pair of first connection subunits, said at least one connection plate and said connection portion are interconnected to form an L-shape, and said connection portion is inverted L-shaped, and
for each of said pair of second connection subunits, said at least one connection plate and said connection portion are interconnected to form an L-shape, and said connection portion is inverted L-shaped.

7. The key device as claimed in claim 6, wherein said at least one connection plate of one of said pair of first connection subunits is connected to said at least one connection plate of another one of said pair of first connection subunits.

8. The key device as claimed in claim 1, wherein
for each of said pair of first connection subunits, said first connection subunit further has a stop portion that is connected to said connection portion, and
for each of said pair of second connection subunits, said second connection subunit further has a stop portion that is connected to said connection portion.

9. The key device as claimed in claim 1, wherein said at least one connection plate of each of said pair of first connection subunits extends from said surrounding frame and away from the imaginary plane when extending towards a central portion of said inner hole, and said at least one connection plate of each of said pair of second connection subunits extends from said surrounding frame and away from the imaginary plane when extending towards said central portion of said inner hole.

10. The key device as claimed in claim 1, wherein
for each of said pair of first connection subunits, said first connection subunit further has at least one guide arc portion that is connected between said at least one connection plate and said connection portion,
for each of said pair of second connection subunits, said second connection subunit further has at least one guide arc portion that is connected between said at least one connection plate and said connection portion.

11. The key device as claimed in claim 1, wherein
for each of said pair of first connection subunits, said at least one connection plate and said connection portion are interconnected to form an L-shape, and said connection portion is inverted L-shaped, and
for each of said pair of second connection subunits, said at least one connection plate and said connection portion are interconnected to form an L-shape, and said connection portion is inverted L-shaped.

12. The key device as claimed in claim 11, wherein said at least one connection plate of one of said pair of first connection subunits is connected to said at least one connection plate of another one of said pair of first connection subunits.

13. The key device as claimed in claim 1, wherein said circuit board unit is a thin film circuit board having a backlight module.
